(19) United States
(12) Patent Application Publication
(10) Pub. No.: US 2009/0158039 A1
(43) Pub. Date: Jun. 18, 2009

(54) DEVICE PAIRING USING "HUMAN-COMPARABLE" SYNCHRONIZED AUDIBLE AND/OR VISUAL PATTERNS

(76) Inventors: Ramnath Prasad, Redmond, WA (US); Nitesh SAXENA, Brooklyn, NY (US)

Correspondence Address: STRAUB & POKOTYLO, 788 Shrewsbury Avenue, TINTON FALLS, NJ, 07724, US

(21) Appl. No.: 12/268,354

(22) Filed: Nov. 10, 2008

Related U.S. Application Data
(60) Provisional application No. 60/986,933, filed on Nov. 9, 2007.

(51) Int. Cl. H04L 9/32

(52) U.S. Cl. 713/168

(57) ABSTRACT

A first device may authenticate a key of a second device (after discovering the second device, and executing a pairing protocol with the second device, wherein a result of the pairing protocol is a bit string) by encoding the bit string, transmitting a human-perceptible representation of the encoded bit string, transmitting a human-perceptible distinctive end of string indicator, receiving human feedback and determining whether or not a key of the second device is authentic based on the received human feedback. At the first device, wireless communications with the second device may be controlled based on the determination of whether or not the key of the second device is authentic.

### 0. PRIORITY CLAIM

This application claims the benefit of U.S. Provisional Patent Application Ser. No. 60/986,933 (incorporated herein by reference and referred to as “the '933 provisional”), titled “EFFICIENT DEVICE PAIRING USING HUMAN-COMPARABLE SYNCHRONIZED AUDIOVISUAL PATTERNS” filed on Nov. 9, 2007, and listing Ramnath PRASAD and Nitesh SAXENA as the inventors. The present invention is not limited to requirements of the particular embodiments described in the '933 provisional.

### 1. BACKGROUND OF THE INVENTION

1.1 Field of the Invention

The present invention concerns securing communications between two devices in an (e.g., short range) insecure wireless network. In particular, the present invention concerns “on the fly” key agreement.

1.2 Background Information

The techniques discussed in this section are not necessarily prior art to the present application and the claimed invention.

Short-range and medium-range wireless communications, based on technologies such as Bluetooth and WiFi, are becoming increasingly popular and promise to remain so in the future. This surge in popularity brings about various security risks. For example, a wireless communication channel is easy to eavesdrop on and to manipulate. Consequently, a fundamental security objective is to secure this communication channel.

In the following, the term “pairing” refers to the operation of bootstrapping secure communication between two devices connected with a short-range wireless channel. Common examples of pairing include pairing of a WiFi-enabled laptop computer and an access point, pairing of a Bluetooth-enabled keyboard and a desktop computer, etc. Pairing would be easy to achieve if there existed a global infrastructure enabling devices to share an on-line or off-line trusted third party, a certification authority, a public key infrastructure (“PKI”), or any pre-configured secrets. However, such a global infrastructure is close to impossible to come by in practice.

A recent research direction to pairing is to use an auxiliary, physically authenticatable channel, called an out-of-band (“OOB”) channel. In some cases, information on an OOB channel is interpreted by humans (e.g., by the users operating the devices). Examples of OOB channels include audio, visual and tactile. An adversary could eavesdrop on, and possibly also delay, drop, and/or replay OOB channels. However, unlike a wireless channel, an adversary is assumed to be incapable of modifying messages on an OOB channel. A pairing scheme using an OOB channel should therefore be secure against such an adversary.

If an OOB channel(s) is to be used for pairing, the usability of a pairing scheme based one or more OOB channels is important. Since the OOB channels typically have low bandwidth, reducing the data that a pairing scheme transmits over these channels should improve usability.

Various pairing protocols using one or more OOB channels have been proposed. These pairing protocols are generally based on the bidirectional automated device-to-device (“d2d”) OOB channels. Unfortunately, such d2d channels require both devices to have transmitters and corresponding receivers. In settings where d2d channel(s) do not exist (e.g., when at least one device does not have a receiver) and even otherwise, pairing protocols can be based upon device-to-human (“d2h”) and human-to-device (“h2d”) OOB channel(s) instead. Depending upon the protocol, only two d2h channels might be sufficient, such as a case in which the user has to perform a very simple operation (such as a comparison) on data received over these OOB channels.

Early pairing protocols required at least 80 to 160 bits of data to be transmitted over the OOB channels. One simple pairing protocol involves devices exchanging their public keys over the wireless channel, and authenticating them by exchanging (at least 80-bits long) hashes of corresponding public keys over the OOB channels. More recently, so-called “Short Authenticated Strings” (“SAS”) based protocols (See, e.g, S. Laur, N. Asokan, and K. Nyberg, “Efficient Mutual Data Authentication Based On Short Authenticated Strings,” IACR Cryptology ePrint Archive: Report, 2005/424, 2005 (incorporated herein by reference), and S. Pasini and S. Vaudenay, “SAS-Based Authenticated Key Agreement,” Theory and Practice of Public-Key Cryptography (PKC), 2006 (incorporated herein by reference).) have reduced the length of data to be transmitted over the OOB channels to only 15 bits or so. (See, e.g., S. Vaudenay, “Secure Communications Over InseCure Channels Based On Short Authenticated Strings,” International Cryptology Conference (CRYPTO), 2005 (incorporated herein by reference).)

A number of pairing schemes with various OOB channels have been proposed. These include pairing schemes using (A) two bidirectional d2d infra-red OOB channels, (B) two bidirectional d2d visual OOB channels consisting of barcodes and photo cameras, (C) a unidirectional d2d visual OOB channel consisting of blinking LED and video camera plus a unidirectional d2h OOB channel consisting of a blinking LED and a unidirectional h2d channel, and (D) two audio/visual d2h OOB channels consisting of MadLib sentences and displayed text. In addition, one SAS-based pairing protocol uses two bidirectional d2h and h2d OOB channels, where a user reads 15 bits of data displayed on one device, inputs the read data on the other device, and vice-versa. Most recently, the paper E. Uzun, K. Karvonen, and N. Asokan, “Usability Analysis of Secure Pairing Methods,” Usable Security (USEC), 2007 (incorporated herein by reference) performed user studies of pairing schemes based on a user comparing the data transmitted over two independent d2h SAS channels.

The aforementioned pairing schemes have varying degrees of usability and are applicable to different device combinations. However, all of the foregoing pairing schemes become inapplicable in pairing scenarios in which (1) both devices do not have good quality transmitters (such as displays, speakers, etc.), and/or (2) both devices do not have relevant receivers (such as cameras, microphones, etc.). Note that the pairing scenarios involving many commodity devices, such as access points, headsets, etc., fall into these categories.

A very recent proposal, C. Soriente, G. Tsudik, and E. Uzun, “BEDA: Button-Enabled Device Association,” International Workshop on Security for Spontaneous interaction (IWSSI), 2007 (incorporated herein by reference) focuses on pairing two devices with the help of “button presses” by the user. That pairing scheme can be used to pair devices with minimal hardware interfaces (such as an LED and a button) using a SAS-based pairing protocol. Unfortunately, however, the results of C. Soriente, G. Tsudik, and E. Uzun, “BEDA: Button-Enabled Device Association,” International Workshop on Security for Spontaneous Interaction (IWSSI), 2007 (incorporated herein by reference) indicate that this pairing scheme is a bit slow.

In short, the previous pairing schemes are either not applicable to certain devices (e.g., due to the one or both devices lacking transmitters and/or receivers with the required quality), or are slow in routinely performed pairing scenarios.

The paper V. Roth, W. Polak, E. Rieffel, and T. Turner, “Simple and Effective Defenses Against Evil Twin Access Points,” ACM Conference on Wireless Network Security (WiSec), short paper, 2008 (incorporated herein by reference) concerns a pairing scheme using d2h OOB “blinking.” That pairing scheme is aimed at the detection of “evil twin” access points in cafes, airport lounges, etc. In that scheme, a user compares “blinks” emitted from the two devices. The user controls when the next bit (“blink” or “no blink”) is to occur by pressing and releasing a button on their device. Unfortunately, this can cause some confusion by the user, particularly for “no blink” bits because the user might conclude their button press/release was ineffective (which it might have been effective, but the next bit of data is a “no blink”). Further, the user's device needs to trigger the display of a next bit on the other device by sending it a signal over the wireless channel. This requires k such (e.g., synchronization) signals for a k-bit long SAS. If one of the k signals is delayed, dropped, or injected, a problem might occur, and in some instances, the user might not even be aware of the problem. Thus, it would be useful to provide improved pairing schemes, using OOB channel(s), for pairing devices in scenarios in which (1) both devices do not have good quality transmitters (such as displays, speakers, etc.), and/or (2) both devices do not have relevant receivers (such as cameras, microphones, etc.). For example, it would be useful to provide improved pairing schemes, using OOB channels, for pairing devices such as one of a WiFi-enabled laptop computer, a personal digital assistant (“PDA”), a cell phone (e.g., without a camera) and an access point, with devices such as one of a Bluetooth-enabled keyboard, a desktop computer, a laptop computer, a PDA, etc.

### 2. SUMMARY OF THE INVENTION

Embodiments consistent with the present invention may be used to pair two devices by authenticating keys of the devices. For example, embodiments consistent with the present invention may be used by a first device to authenticate a key of a second device. At least some exemplary embodiments consistent with the present invention may do so (after discovering the second device, and executing a pairing protocol with the second device, wherein a result of the pairing protocol is a bit string) by encoding the bit string, transmitting a human-perceptible representation of the encoded bit string, transmitting a human-perceptible distinctive end of string indicator, receiving human feedback and determining whether or not a key of the second device is authentic based on the received human feedback. At the first device, wireless communications with the second device may be controlled based on the determination of whether or not the key of the second device is authentic.

In at least some embodiments consistent with the present invention, the human-perceptible representation of the encoded bit string transmitted by the first device is a series of audible beeps. In such embodiments, the series of audible beeps might have a sleep interval of between 300 ms and 500 ms. In such embodiments, the transmission of the human-perceptible representation of the encoded bit string might have a length of between six and eleven seconds.

In at least some other embodiments consistent with the present invention, the human-perceptible representation of the encoded bit string transmitted by the first device is a series of visually-perceptible blinks. In such embodiments, the series of visually-perceptible blinks might have a sleep interval of between 300 ms and 800 ms. In such embodiments, the transmission of the human-perceptible representation of the encoded bit string might have a length of between six and seventeen seconds.

In at least some exemplary embodiments consistent with the present invention, the second device might perform the same acts as the first device. Both devices might use beeping, both devices might use blinking, or one device might use beeping while the other uses blinking.

### 3. BRIEF DESCRIPTION OF THE DRAWINGS

FIG. 1 illustrates an exemplary environment in which two devices are paired using out-of-band channels with a human (user), in a manner consistent with the present invention.

FIG. 2 illustrates the operation of a prior SAS-based pairing protocol.

FIG. 3 illustrates the encoding of bits as beeps and silence, and an end indicator encoded as a buzz.

FIG. 4 illustrates the encoding of bits as green LED blinks and no emission, and an end indicator encoded as a red LED blink.

FIG. 5 is a diagram illustrating exemplary operations and modules that may be used in an exemplary device, such as the devices 110, 115 described above with reference to FIG. 1.

FIG. 6 is a flow diagram of an exemplary method 600 for performing device pairing in a manner consistent with the present invention.

### 4. DETAILED DESCRIPTION

The present invention may involve novel methods, apparatus, message formats, and/or data structures to facilitate on the fly key agreement between two devices in an insecure wireless network. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

### 4.1 General Environment and Method for Providing Device Pairing Using Device-to-Human Out-of-Band Channels

In at least some embodiments consistent with the present invention, the devices being paired are connected via two types of channels—a short-range, high-bandwidth bidirectional wireless channel(s), and an auxiliary low-bandwidth physical OOB channel(s). Based on device types, the OOB channel(s) can be device-to-device (d2d), device-to-human (d2h) and/or human-to-device (h2d). As discussed in § 1.2 above, d2d OOB channels are inapplicable in pairing scenarios in which (1) both devices do not have good quality transmitters (such as displays, speakers, etc.), and/or (2) both devices do not have relevant receivers (such as cameras, microphones, etc.). Thus, embodiments consistent with the present invention can use d2h (and h2d) OOB channels.

To be conservative, an adversary attacking the pairing protocol is assumed to have full control on the wireless channel. That is, it is assumed that an adversary can eavesdrop, delay, drop, replay and modify messages. However, on the OOB channel, it is assumed that the adversary can eavesdrop, delay, drop, replay and re-order messages, but can not modify them. In other words, the OOB channel is assumed to be an authenticated channel.

The security model for a pairing protocol in this setting is adopted from the model of authenticated key agreement. In this model, a multi-party setting is considered in which a number of parties simultaneously run multiple/parallel instances of pairing protocols. In practice, however, it is reasonable to assume only two-parties running only a few serial/parallel instances of the pairing protocol. For example, during authentication for an ATM transaction, there are only two parties, namely the ATM machine and a user, restricted to only three authentication attempts. This security model does not consider denial-of-service (DoS) attacks. (Note that on wireless channels, explicit attempts to prevent DoS attacks might not be useful because an adversary can simply launch an attack by jamming the wireless signal.)

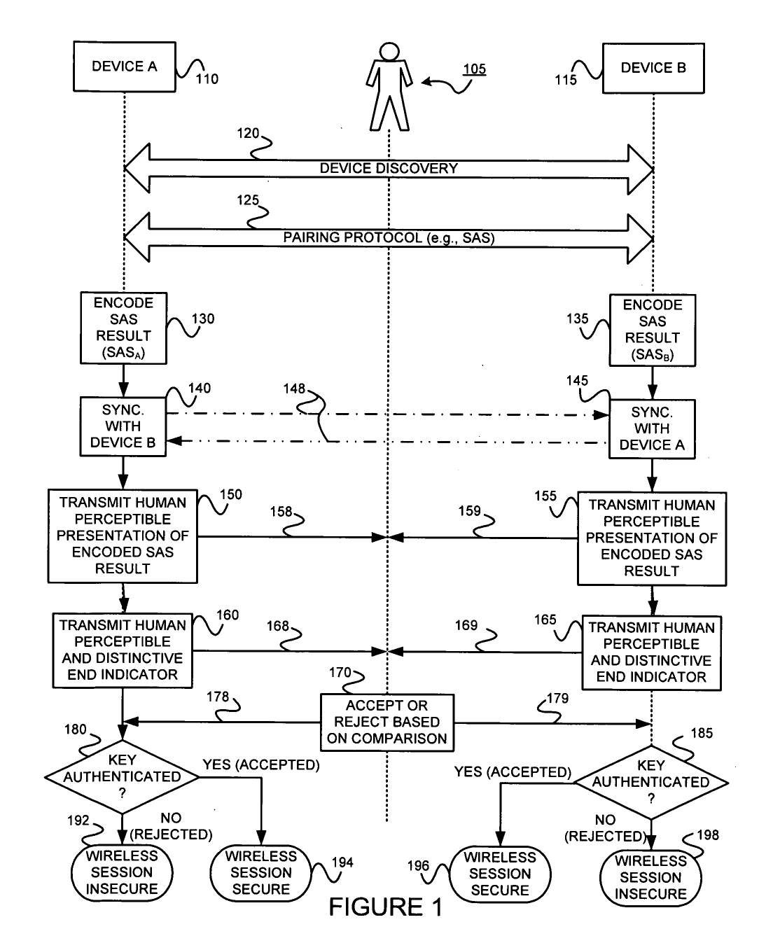

FIG. 1 illustrates an exemplary environment in which two devices 110 and 115 are paired using out-of-band channels with a human (user) 105, in a manner consistent with the present invention. Referring to FIG. 1, the pairing scheme, in its entirety, includes three phases. First, in a device discovery phase, the devices 110 and 115 exchange their identifiers over a wireless channel, before further communications. (Communication 120) Second, in a pairing protocol execution phase, the devices execute a desired pairing protocol over the wireless channel. (Communication 125) Third, in an authentication phase, the devices 110 and 115, authenticate the messages exchanged during the previous phase using OOB channels. (OOB Communications 148, 158, 159, 168, 169, 178 and 179)

The first two phases may use known or proprietary techniques, understood by those skilled in the art. For example, the pairing protocol execution phase may use known SAS protocols, such as those described in S. Pasini and S. Vaudenay, “SAS-Based Authenticated Key Agreement,” Theory and Practice of Public-Key Cryptography (PKC), 2006 (incorporated herein by reference), or S. Laur, N. Asokan, and K. Nyberg, “Efficient Mutual Data Authentication Based On Short Authenticated Strings,” TACR Cryptology ePrint Archive: Report, 2005/424, 2005 (incorporated herein by reference).

Assume, for example, that device A 110 and device B 115 have performed the device discovery and protocol execution phases over the wireless channel and that SAS was used during the protocol execution phase. During the authentication phase, the devices 110 and 115 encode the 15-bits of their respective SAS data SAS_{A} and SAS_{B} (Blocks 130 and 135) and synchronize with each other (Blocks 140 and 145, and one or more communications 148). As described in greater detail below, the bits may be encoded into beeps, and/or blinks. The devices 110 and 115 then transmit, to user 105, their respective encoded SAS results as human-perceptible presentations. (Blocks 150 and 155, and d2h OOB communications 158 and 159) Similarly, the devices 110 and 115 then transmit, to user 105, a distinctive human-perceptible END (of bit string transmission) indicator. (Blocks 160 and 165, and d2h OOB communications 168 and 169) The user 105 can compare the transmissions to determine if they match, and send to one or both devices 110 and 115, accept or reject feedback. (Block 170 and h2d OOB communication(s) 178 and 179) The devices 110 and 115 can use the user 105 feedback to determine whether or not the key of the other device has been authenticated. If so (KEY ACCEPTED), the device can assume that a wireless session with the other device is secure. (Decision blocks 180 and 185, and nodes 194 and 196) If, on the other hand, the key of the other device has not been authenticated (KEY REJECTED), the device should conclude that a wireless session with the other device is not secure. (Decision blocks 180 and 185, and nodes 192 and 198)

Further processing by the devices 110 and 115, and/or further actions by user 105, may use the key authentication determination.

4.1.1 Exemplary Pairing Protocols

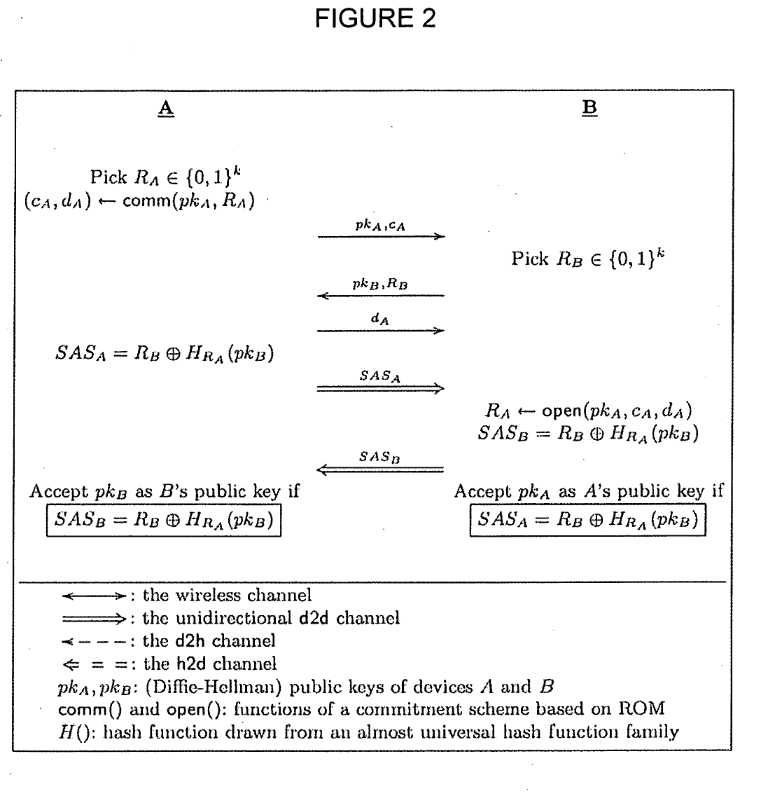

Referring back to 125 (and blocks 130 and 135) of FIG. 1, at least some exemplary pairing protocols consistent with the present invention may be based on short authenticated strings (“SAS”), such as those proposed in S. Pasini and S. Vaudenay, “SAS-Based Authenticated Key Agreement,” Theory and Practice of Public-Key Cryptography (PKC), 2006 (incorporated herein by reference), or S. Laur, N. Asokan, and K. Nyberg, “Efficient Mutual Data Authentication Based On Short Authenticated Strings,” IACR Cryptology ePrint Archive: Report, 2005/424, 2005 (incorporated herein by reference). For the sake of completeness, FIG. 2 depicts the protocol of S. Pasini and S. Vaudenay, “SAS-Based Authenticated Key Agreement,” Theory and Practice of Public-Key Cryptography (PKC), 2006 (incorporated herein by reference). In a communication setting involving two users restricted to running three instances of the protocol, these SAS protocols need to transmit only k (e.g., k=15) bits of data over the OOB channels. If the cryptographic primitives used in the protocols are secure, an adversary attacking these protocols can not win with a probability significantly higher than 2^{-k} (e.g., 2-15). This provides security equivalent to the security provided by 5-digit PIN-based ATM authentication.

Since a user 105 will “compare” the data transmitted over two d2h channels 158 and 159, at least some exemplary pairing schemes consistent with the present invention can be based on the existing SAS protocols. This is because in these protocols, the SAS messages are computed as a common function of the public keys and/or random nonces exchanged during the protocol. Consequently, the authentication is based upon whether the two SAS messages match or not. The security of these SAS-based protocols is based upon different cryptographic assumptions. For example, the security in S. Pasini and S. Vaudenay, “SAS-Based Authenticated Key Agreement,” Theory and Practice of Public-Key Cryptography (PKC), 2006 (incorporated herein by reference) is based upon the random oracle model (“ROM”), while the security in S. Laur, N. Asokan, and K. Nyberg, “Efficient Mutual Data Authentication Based On Short Authenticated Strings,” IACR Cryptology ePrint Archive: Report, 2005/424, 2005 (incorporated herein by reference) is not. Moreover, these protocols have different computational requirements. Therefore, based upon the security requirements and underlying devices, exemplary pairing schemes consistent with the present invention can use either of the SAS protocols, as desired. Naturally, other pairing protocols may be used. However, the result (in the case where the keys are authenticated) should be relatively short, synchronized, bit strings.

4.1.2 Exemplary Key Authentication

Recall from § 4.1, in an authentication phase, the devices 110 and 115, authenticate the messages exchanged during the previous phase using OOB channels. Recall also that this involves encoding, synchronization and OOB transmissions. Note that synchronization may occur after or before the pairing protocol (SAS) bit string result is encoded. Exemplary synchronization techniques consistent with the present invention are described in § 4.1.2.1 below. Then, exemplary encoding and transmission techniques are described in § 4.1.2.2 below.

4.1.2.1 Exemplary Synchronization

Referring back to 140 and 145 of FIG. 1, to achieve synchronization, in at least some embodiments consistent with the present invention, one device 110 or 115 may send a synchronization signal S (dot dash 148 or double-dot dash 148) to the other device 115 or 110 over the wireless channel. The devices 110 and 115 then encode the bit string resulting from the pairing protocol (if they have not already done so) and start transmitting the encoded data right after sending and receiving the bit S (or after a predetermined delay time). Naturally, other synchronization techniques may be used.

Although communications related to synchronization may occur over the wireless channel, in some alternative embodiments consistent with the present invention, the synchronization signals can be communicated over another additional or alternative channel(s).

It is possible for the synchronization signal S to be modified, delayed or dropped (either maliciously or otherwise), possibly fooling the users into accepting non-matching SAS strings. Consider, for example, strings SAS_{A}=“010010” and SAS_{B}=“100100”. These strings will appear to be the same to the user 105 comparing them if the synchronization signal is delayed by one bit. Referring back to blocks 160 and 165 of FIG. 1, to counter this, the end of each SAS string may be provided with an END marker to indicate the end of the SAS bit-string. The END indicator should be easily distinguished from the human perceptible encoding (e.g., beeping and/or blinking) of the SAS strings in order to enable the user 105 to detect synchronization errors.

4.1.2.2 Exemplary Encoding and Transmission Techniques

Referring back to blocks 130, 135 encoding should enable the user to easily identify both the good cases (i.e., when SAS_{A}=SAS_{B}) and the bad ones (i.e., when SAS_{A}≠SAS_{B}). Embodiments consistent with the present invention may use Beep-Beep, Blink-Blink, or Beep-Blink combinations in a manner that can be used on most devices and that the users will likely find simple and easy to perform. To this end, in at least some embodiments consistent with the present invention, one or both devices may transmit SAS bit encoding “beeps” (and an END of SAS bit indicator) as simple sounds (such as “system beep” and “buzz” for example) which can be easily distinguished even amidst some noise. Similarly, in at least some embodiments consistent with the present invention, one or more devices may transmit SAS bit encoding “blinks” (and an END of SAS bit indicator) as system LED flashes.

The foregoing supports pairing scenarios in which both devices do not have good transmitters (e.g., displays) and only at most one device has a receiver (e.g., cameras). Recall that these scenarios include, for example, pairing of a laptop computer with an access point, a keyboard with a desktop computer, a cell phone with an access point, etc.

More details of exemplary Beep-Beep, Blink-Blink, and Beep-Blink encoding are described in §§ 4.1.2.2.1 through 4.1.2.2.3, respectively, below.

4.1.2.2.1 Beep-Beep Encoding

Beep-Beep encoding requires both devices 110, 115 to have audio transmitters (such as, for example, basic speakers or “beepers”). In such embodiments, the two devices encode their respective SAS strings using a sound denoted by “S1” (a “1” bit corresponds to the sound S1 and a “0” bit corresponds to a “silence” for a certain period). The two devices also encode the END indicators using a distinct sound, denoted by “S2”. The user 105 listens to both devices 110 and 115 and determines whether or not the devices play the two sounds S1 and S2 in synchronization with each other. In other words, if S1 on one device is not played in synch with S1 on the other device, or if S2 on one device is not played in synch with S2 on the other device, the user 105 rejects the key authentication. If, on the other hand, both S1 on one device is played in synch with S1 on the other device and S2 on one device is played in synch with S2 on the other device, the user 105 accepts the key authentication.

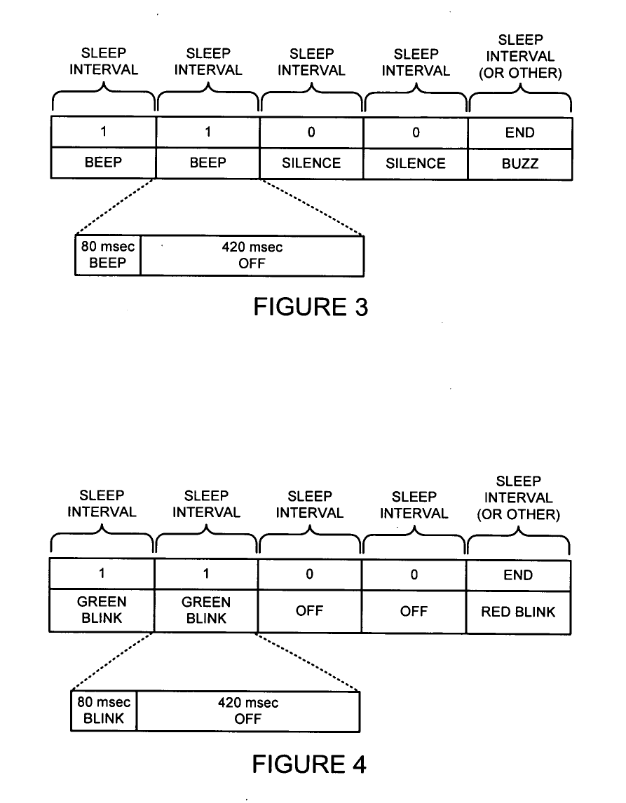

In at least some embodiments consistent with the present invention, a “1” bit in the SAS string might be signaled using a “system beep”, whereas a “0” bit might be signaled using a “silence” for a certain period of time. The END indicator might be signaled using a distinctive “buzz”. Every audible or silent bit signal is followed by a brief silence. The total period for the audible or silent period and the brief silence is referred to as the “sleep interval”. More specifically, since human user comparison is integral to the pairing scheme, it is important that users can identify two distinct bit signals. The “sleep interval” includes a brief silence for this purpose. A longer “sleep interval” should make the comparison easier for a person. However, assuming a fixed time for signaling a beep or silence “1” or “0” bit value, the minimum time for a user to compare two SAS strings is inversely proportional to the duration of the sleep interval. That is, the shorter the sleep interval, the faster the comparison, and vice-versa. Based on experiments conducted by the present inventors and described in detail in the '933 provisional, a 300-500 msec range for the sleep interval was found to work well. This is illustrated in FIG. 3.

4.1.2.2.2 Blink-Blink Encoding

Blink-Blink encoding requires both devices 110 and 115 to have visual transmitters. In a simple case, this may be LEDs, which are provided on many electronic devices. In cases where devices have good displays, the whole screen or a part of the screen might be used as a transmitter.

In at least some exemplary embodiments consistent with the present invention, the two devices encode their respective SAS strings into blinking of a green LED (a “1” bit corresponds to a “blink” period, while a “0” bit corresponds to an “off” period. The two devices also encode the END indicators using the glowing of a red LED. The user looks at the two devices and determines if the green LEDs on two devices blink in synchronization with each other and if the red LEDs glow together. In other words, if the green LED on one device does not blink in synch with the green LED on other device, or if the red LED on one device does not glow in synch with the red LED on the other device, the user 105 rejects the key authentication. If, on the other hand, both the green LED on one device blinks in synch with the green LED on the other device and the red LED on one device glows in synch with the red LED on the other device, the user 105 accepts the key authentication.

In one exemplary implementation, two LEDs (one green and one red) were connected to the data pin of the parallel port of a desktop. Upon receiving a “1” bit in the SAS string, at the data pin, a voltage is applied at that particular data pin and the green LED “glows” while receiving this voltage. The voltage stays on unless it is explicitly cleared. Since, however, the present inventors have found that “blinking” is more suitable than the “glowing”, when the bit is a “1”, a voltage is applied to the pin for a fixed time interval a, followed by another fixed time interval b where voltage to the data pin is cut off. As with the exemplary encoding using system beep described in § 4.1.2.2.1 above, the time interval a+b is referred to as the “sleep interval”. For example, for a “1” bit, the green LED might be set to glow for 80 msec (a=80 msec) and then stay off for the next 420 msec (b=420 msec). For a “0” bit, the green LED stays off for the entire 500 msec (a+b=500 msec). FIG. 4 illustrates the encoding process using a sleep interval of 500 msec. The END marker is similarly implemented using a red LED.

The Blink-Blink combination fared well with a 300-800 msec sleep interval. The 300 msec sleep interval may have 80 msec of a “glow” and 220 msec of an “off”. A 500 msec sleep interval may have 150 msec of a “glow” and 350 msec of an “off”. The 800 msec sleep interval may have 300 msec of a “glow” and 500 msec of an “off”. In each case, the sleep interval for the “blinking” END marker may be set to 800 msec, corresponding to 300 msec of a “glow” and 500 msec of an “off”. This higher value was chosen for the users to be able to easily identify any mismatch in the END markers.

4.1.2.2.3 Beep-Blink Encoding

The combined Blink-Beep encoding requires one device to have an audio transmitter and the other to have a visual transmitter. Device A 110 encodes its SAS string using sound S1 and the END marker using sound S2 (as described in § 4.1.2.2.1 above), and device B 115 encodes its SAS string into blinking of a green LED and the END marker by glowing a red LED (as described in § 4.1.2.2.2 above). The user 105 listens to device A 110 while looking at device B 115 and determines if S1 is played in synchronization with the blinking of the green LED and if S2 is played with the glowing of the red LED. In other words, if S1 on device A 110 is not played in synchronization with the green blinking LED on device B 115, or if S2 on device A 110 is not played in synchronization with the glowing of the red LED on device B 115, the user 105 rejects the key authentication. If, on the other hand, both S1 on device A 110 is played in synch with the green blinking LED on device B 115 and S2 on device A 110 is played in synch with the glowing of the red LED on device B 115, the user 105 accepts the key authentication. A sleep interval for the Beep-Blink combination in the range 300-500 msec may be used. A 300 msec sleep interval blink may have 80 msec of a “glow” and 220 msec of an “off”. A 400 msec sleep interval blink may have 80 msec of a “glow” and 320 msec of an “off”. A 500 msec sleep interval may correspond to 80 msec of a “glow” and 420 msec of an “off”.

In each case, the sleep interval for the “blinking” END marker may be set to 800 msec, corresponding to 300 msec of a “glow” and 500 msec of an “off”. This higher value was chosen for the users to be able to easily identify any mismatch in the END markers.

### 4.2 Exemplary Apparatus

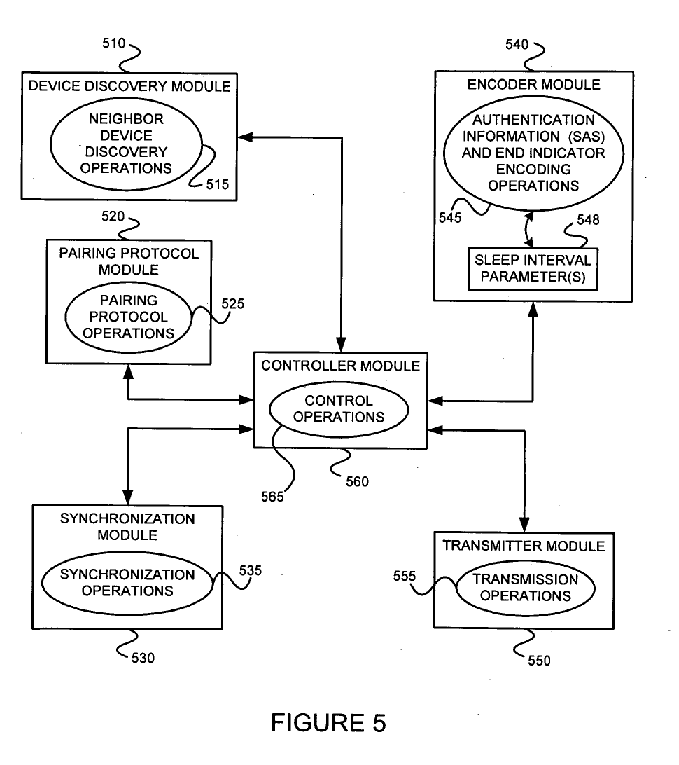

FIG. 5 is a diagram illustrating exemplary operations and modules that may be used in an exemplary device, such as the devices 110, 115 described above with reference to FIG. 1. The exemplary device may perform neighbor discovery operations 515, pairing protocol operations 525, synchronization operations 535, authentication information (e.g., SAS) and end indicator encoding operations 545, transmission operations 555 and control operations 565. The control operations 565 may control the performance of the other operations 515, 525, 535, 545 and 555. The operations may exchange information via one or more direct links, one or more buses, one or more networks, and/or one or more software calls. Device discovery module 110 may perform the neighbor discovery operations 515, and may be implemented as hardware (e.g., including a wireless transmitter) and/or software (e.g., program instructions stored on processor readable memory and executed) on the device. Pairing protocol module 520 may perform the pairing protocol operations 525, and may be implemented as hardware (e.g., a microprocessor, an application specific integrated circuit, etc.), and/or software (e.g., program instructions stored on processor readable memory and executed) on the device. Synchronization module 530 may perform the synchronization operations 535, and may be implemented as hardware (e.g., a wireless transmitter) and/or software (e.g., program instructions stored on processor readable memory and executed) on the device. Encoder module 540 may perform the authentication information (e.g., SAS) and end indicator encoding operations 545, and may be implemented as hardware and/or software (e.g., program instructions stored on processor readable memory and executed) on the device. The transmitter module 550 may perform the transmission operations 555, and may be implemented as hardware (e.g., LED, speaker, display, etc.), and/or software (e.g., program instructions stored on processor readable memory and executed) on the device. Finally, the controller module 560 may perform the control operations 565, and may be implemented as hardware (e.g., a microprocessor, an application specific integrated circuit, etc.) and/or software (e.g., control program instructions stored on a processor readable memory and executed) on the device. Although not shown, the device should include means for receiving human feedback (e.g., an accept or reject input). Thus, for example, the device may include one one or more buttons to be pressed by the user. Obviously, other input means may be used. Although not shown, one or more operations may be performed by a single module. Although not shown, a single operation may be performed over more than one module.

### 4.3 Refinements, Alternatives and Extensions

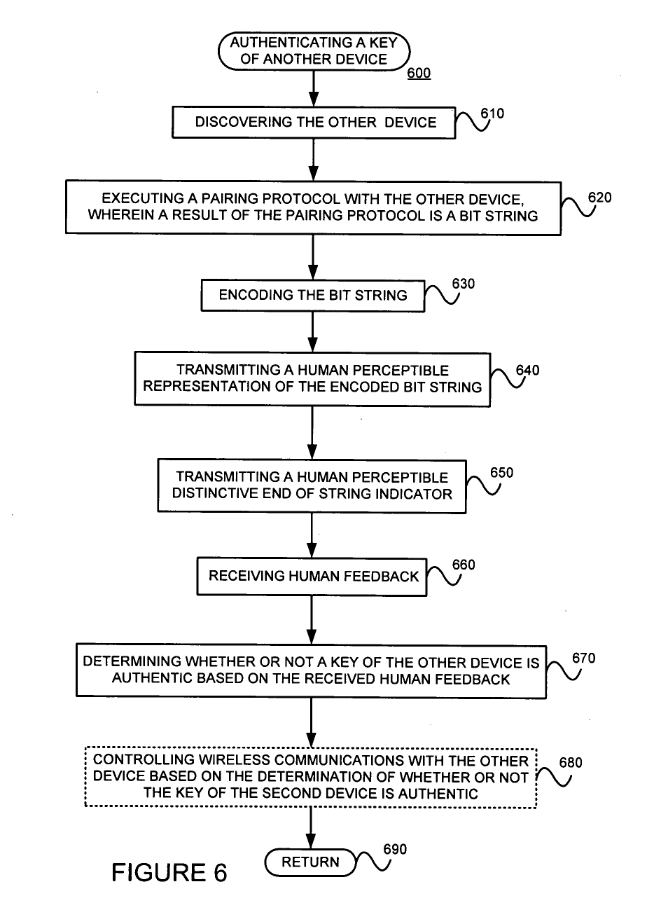

FIG. 6 is a flow diagram of an exemplary method 600 for performing device pairing in a manner consistent with the present invention. The method 600 is to be run by a device, and another instance of the method 600 is to be run by the other device. The other device is discovered (Block 610), and a pairing protocol is executed with the other device, wherein a result of the pairing protocol is a bit string (Block 620). The bit string is then encoded (Block 630) and transmitted as a human-perceptible representation (e.g., as blinks, beeps, etc.) (Block 640). Note that this transmission is to be done in synch with a corresponding transmission by the other device. A human-perceptible distinctive end of string indicator is then transmitted. (Block 650) Note also that this transmission is to be done in synch with a corresponding transmission by the other device. Human feedback is received (Block 660). Finally, whether or not a key of the other device is authentic is determined based on the received human feedback. (Block 670) Wireless communications with the other device may be controlled based on this determination (Block 680) before the method is left (Node 690).

To counter certain user errors, it may be desirable to prepend a number of bits (e.g., five bits) to the SAS string as a “learning phase.” The prepended bits may be all 1's at both devices. (For obvious reasons, using too many all 0's might defeat the purpose of the training.) Prepending learning bits to the SAS string gives users a learning time. Including this learning phase improved the accuracy of pairing schemes consistent with the present invention to a great extent.

In addition to the single user pairing scenarios, embodiments consistent with the present invention may be used in scenarios where two users pair their individual devices, such as their cell phones, laptop computers, etc.

### 4.4 Conclusions

As can be appreciated from the foregoing, pairing schemes consistent with the present invention may be universally applicable to pair any two devices (provided that each has an audio output, such as a simple speaker, or a visual output, such as a simple LED). Such pairing schemes can use existing SAS protocols. They do not require devices to have good transmitters or any receivers (e.g., even a pair of LEDs would be sufficient). The scheme involves users comparing very simple audio, and/or video patterns, such as “beeping”, and/or “blinking”, transmitted as simultaneous streams, forming two synchronized d2h channels. Thus, embodiments consistent with the present invention can overcome one of the main challenges of device pairing—namely, the lack of good quality output interfaces (e.g., a speaker, display) as well as receivers (e.g., a microphone, camera) on both devices. Such embodiments do not require devices to have good transmitters or any receivers. Rather, they are based upon the device user(s) comparing short and simple synchronized audiovisual patterns, such as in the form of “beeping” and “blinking”.

The devices may be ad hoc in nature. That is, they need not have a prior context (such as pre-shared secrets) with each other, and they need not share a common trusted on-line or off-line authority. However, the devices can generally be connected using auxiliary physical channel(s) (such as audio, visual) that can be authenticated by the device user(s), and thus form the basis for pairing. Thus, “on the fly” key agreement is enabled.

Embodiments consistent with the present invention may also be used to establish unidirectional authentication, such as between a printer and a laptop.

Test results indicate that the Blink-Blink and Beep-Blink combinations perform very efficiently and robustly, with the former being preferable. The Blink-Blink and Beep-Blink combinations are quite efficient even in pairing scenarios where both devices do not have good quality transmitters and only at most one device has a relevant receiver. The Blink Blink combination can typically only be used for pairing two similar devices (such as a Bluetooth-enabled headset and a cell phone, two laptop computers, two cell phones, etc.) that are physically very close by and can be aligned properly with each other. The Beep-Blink combination, on the other hand, can be used for any two devices (generally, one of the devices being paired has an audio transmitter and the other has LEDs). Moreover, the Beep-Blink combination is applicable irrespective of the extreme proximity of devices. Thus, for example, the Beep-Blink combination may be used for pairing a wall-mounted access point with other devices even when such other devices cannot be positioned close to the access point.

The Blink-Blink and Beep-Blink combinations might even be useful in instances where devices have good transmitters (and also have receivers), and other OOB channels could therefore be used.

What is claimed is:

1. A method, for use by a first device, for authenticating a key of a second device, the method comprising:
a) executing a pairing protocol with the second device, wherein a result of the pairing protocol is a bit string;
b) encoding the bit string;
c) transmitting a human-perceptible representation of the encoded bit string;
d) transmitting a human-perceptible distinctive end of string indicator;
e) receiving human feedback; and
f) determining whether or not a key of the second device is authentic based on the received human feedback.

2. The method of claim 1 wherein the human-perceptible representation of the encoded bit string transmitted by the first device is a series of audible beeps.

3. The method of claim 2 wherein the series of audible beeps have a sleep interval of between 300 ms and 500 ms.

4. The method of claim 2 wherein the transmission of the human-perceptible representation of the encoded bit string has a length of between 6 and 11 seconds.

5. The method of claim 1 wherein the human-perceptible representation of the encoded bit string transmitted by the first device is a series of visually-perceptible blinks.

6. The method of claim 5 wherein the series of visually-perceptible blinks have a sleep interval of between 300 ms and 800 ms.

7. The method of claim 5 wherein the transmission of the human-perceptible representation of the encoded bit string has a length of between 6 and 17 seconds.

8. The method of claim 1 further comprising discovering the second device using wireless communications.

9. The method of claim 1 wherein the act of executing a pairing protocol with the second device is performed using wireless communications.

10. The method of claim 1 wherein the act of executing a pairing protocol with the second device is performed using unsecure wireless communications.

11. The method of claim 1 wherein the pairing protocol is a short authenticated string paring protocol.

12. The method of claim 1 further comprising:
g) controlling wireless communications with the second device based on the determination of whether or not the key of the second device is authentic.

13. A method for authenticating key of a first device and a second device, the method comprising:
a) executing, with the first device, a pairing protocol with the second device, to generate a first bit string;
b) executing, with the second device, a pairing protocol with the first device, to generate a second bit string;
c) encoding, with the first device, the first bit string;
d) encoding, with the second device, the second bit string;
e) transmitting, with the first device, a human-perceptible representation of the encoded first bit string;
f) transmitting, with the second device, a human-perceptible representation of the encoded second bit string, wherein the transmission by the second device is synchronized with the transmission by the first device;
g) transmitting, with each of the first and second devices, a human-perceptible distinctive end of string indicator;
h) receiving, with the first device, human feedback;
i) receiving, with the second device, human feedback;
j) determining, with the first device, whether or not a key of the second device is authentic based on the received human feedback; and
k) determining, with the second device, whether or not a key of the first device is authentic based on the received human feedback.

14. The method of claim 13 further comprising:
l) controlling wireless communications between the first device and the second device based on the determinations of whether or not the respective keys of the first device and the second device are authentic.

15. Apparatus for authenticating a key of a second device, the apparatus comprising:
a) means for executing a pairing protocol with the second device, wherein a result of the pairing protocol is a bit string;
b) means for encoding the bit string;
c) means for transmitting a human-perceptible representation of the encoded bit string;
d) means for transmitting a human-perceptible distinctive end of string indicator;
e) means for receiving human feedback; and
f) means for determining whether or not a key of the second device is authentic based on the received human feedback.

16. The apparatus of claim 15 wherein the human-perceptible representation of the encoded bit string transmitted by the first device is a series of audible beeps.

17. The apparatus of claim 15 wherein the human-perceptible representation of the encoded bit string transmitted by the first device is a series of visually-perceptible blinks.

18. The apparatus of claim 15 wherein the pairing protocol is a short authenticated string paring protocol.

19. The apparatus of claim 15 further comprising:
g) means for controlling wireless communications with the second device based on the determination of whether or not the key of the second device is authentic.
